(19) United States
(12) Patent Application Publication
(10) Pub. No.: US 2005/0023050 A1
(43) Pub. Date: Feb. 3, 2005

(54) Portable motorized trailer dolly

(76) Inventors: Craig Chidlow, Los Gatos, CA (US); Jan G. Sprohge, Santa Cruz, CA (US); Daniel Andrew Attema, Santa Cruz, CA (US); Steven G. Reyling, Livermore, CA (US); Lubomir Skrobak, Saratoga, CA (US)

Correspondence Address: JAMES D IVEY, 3025 TOTTERDELL STREET, OAKLAND, CA, 94611-1742, US

(21) Appl. No.: 10/632,141

(22) Filed: Jul. 30, 2003

(51) Int. Cl. B62D 1/00

(52) U.S. Cl. 180/11

(57) ABSTRACT

A trailer dolly includes an internal combustion engine, a transmission providing both forward and reverse drives, and a centralized lifting handle. The internal combustion engine provides much better power and much less weight than electric counterparts. The forward/reverse transmission includes a sliding shaft which engages a select one of two bevel gears with a larger bevel gear to select forward or reverse drive. The sliding shaft slides along with an elongated clutch cylinder of a centrifugal clutch. An alternative transmission uses sprockets and chains to obviate a case to enclose lubricant. Counter-rotating sprockets alternatively engage a dog-tooth gear to select either forward or reverse drive. The lifting handle mounted generally at the center of gravity (with the trailer dolly in a substantially horizontal position) makes single-handed lifting and carrying of the trailer dolly quite easy.

### FIELD OF THE INVENTION

The invention is related to the field of trailer dollies and specifically to a powered device for moving trailers such as recreational vehicle trailers without an attached towing vehicle.

### BACKGROUND

Trailer dollies have been used to assist people moving trailers without the use of a car or truck. Common applications for trailer dollies typically involve maneuvering a trailer in areas not suitable for use with a tow vehicle, such as parking a trailer in (i) a tight parking spot, (ii) a lockable storage space with insufficient space between the storage units to maneuver a car or truck with the trailer, (iii) a parking area not reachable by car or truck, (iv) a narrow garage entrance, or (v) an off road area.

A trailer dolly aims to enable movement of a trailer without a tow vehicle such as a car, truck, or other large vehicle. A trailer dolly connects to the trailer typically on or near a ball coupling which is part of a front coupling portion of the trailer and includes a wheel or wheels on which the front coupling portion is supported. These supporting wheels of the trailer dolly can rotate freely—moved by manual force—or be motor driven to move the trailer. Trailer dollies are typically manually steered.

Common commercially available trailer dollies are generally motorized or unmotorized. Unmotorized trailer dollies are manually propelled by a human operator to maneuver the trailer dolly and an attached trailer. As a result, unmotorized trailer dollies are limited as a practical matter to rather small trailers since most people cannot manually move even moderately sized trailers and even then only on flat and level ground.

Motorized trailer dollies contain a power source for moving the trailer dolly and an attached trailer. Such motorized trailer dollies are not portable in that they are impractical for a typical individual human to physically lift and carry—especially when including all components of the trailer dolly such as deep cycle batteries which power electric trailer dollies. Some trailer dollies include rolling casters or free rotating wheels to facilitate mobility of the trailer dolly when not attached to a trailer. The rolling casters or free wheels are used to roll the dolly into position and back to the storage location. However, true portability as used herein requires that the trailer dolly can be readily transported along with the trailer for use at a remote location. Even electrically-powered trailer dollies which rely on external power sources typically weigh about 80 pounds.

Available for sale for over thirty years, the market for trailer dollies has been limited by their functionality and portability issues; however, the retail market for various models of trailers showing a trend toward ever increasing payloads has steadily been growing. Manual trailer dollies are typically sold for trailers under a total weight of 1,250 lbs since the amount of force required to move heavier trailers is generally too great for a typical person. Trailers under 1,250 lbs. can be motorcycle trailers, small sail boat trailers, or single personal watercraft (e.g., Jet Ski®) trailers, for example.

Some currently available commercial motorized trailer dollies include electrical motors that use either (i) household alternating current (AC) with one or more extension cords or (ii) one or more direct current (DC) batteries. AC trailer dollies require the operator to be near to a 110/220-volt outlet while being cautious to stay clear of water which presents a risk of electrical shock. AC trailer dollies consume in excess of eight amps of current and the manufacturers provide warnings to use rubber-soled shoes or boots when operating an AC trailer dolly.

Manufacturers of DC trailer dollies typically recommend using a towing vehicle's deep cycle battery or a similar stand alone deep cycle battery as the power supply for their product. These deep cycle requirements support the high current necessary to drive a one-quarter horsepower (HP) or greater, 12-volt DC motor which typically requires in excess of 30 amps during high torque operation. Such a battery with these types of loads generally requires recharging and maintenance that ultimately requires location near a 110/220-volt outlet, e.g., to use a battery charger, or running the tow vehicle's engine that supplied the electrical power.

Using a tow vehicle's battery may not be a practical option in some circumstances since high current loads risk damage to the vehicle's electronics or engine control modules. Appropriate care is also required due to the inherent risks of battery acid leakage. “Portability” of DC trailer dollies compared to the similarly designed AC trailer dollies from companies such as Power Caster Inc. (of Temple City, Calif.), and Powermovers Inc. (of Stanton, Calif.) is limited due to factors associated with high capacity deep cycle batteries. Ultra-Fab (of Elkhart, Ind.) has designed trailer dollies with integrated batteries for use at RV and boat lots. The smallest device currently offered by this company starts at 285 lbs in weight and their products are maneuvered by “driving” them into position.

Another commercially available motorized trailer dolly is made by Powrwheel Limited, a company based in the United Kingdom. They manufacture AC and DC trailer dollies and have special cables that connect to a battery of trailered vehicle such as a recreational vehicle or boat, or to a trailer-mounted battery, or to a standalone battery. These dollies with battery cables for connection to a separate vehicle's battery require extension cabling and increase the risk of draining the vehicle's battery beyond its reserve capacity, resulting in an inability to subsequently start the vehicle. If such a trailer dolly is used to maneuver a trailer into position for long term storage, the borrowed battery of the trailered vehicle can be stored for long periods in a discharged state. Such risks substantial damage to the battery plates. It may be tempting to run the engine of the trailered vehicle which powered the dolly to thereby recharge the trailered vehicle's battery prior to long-term storage. However, running the engine of a trailered power boat to provide such charging power may not be possible since a majority of boats use open cooling systems requiring the presence of water to run the engine. Without water present for running the engine, an AC battery charger would be required to recharge the boat's battery—both for starting the boat engine and for trailer maneuvering power.

Another Powrwheel Limited model includes a battery integrated into a trailer dolly. The integrated battery adds substantial weight to their product, substantially reducing portability of the trailer dolly.

Trailer dollies powered by internal combustion engines generally suffer from the fact that internal combustion engines are not reversible. Electric trailer dollies simply reverse electric poles to provide a reverse drive for maneuvering trailers. However, trailers dollies with internal combustion engines typically provide elaborate and intricate designs allowing the trailer dolly to be rotated about to provide the equivalent of reverse drive. The reason for this is that a transmission would add significant weight and cost to the trailer dolly.

In summary, currently available trailer dollies do not offer features intending maximum portability coupled with ease of use through simplification of the dolly design. To be truly portable, a single person of normal strength should be able to lift the dolly by hand. In addition, a method to easily store and transport the dolly should be offered. Currently available designs rely on the dolly either being stored at a fixed location or being transported loose in a car trunk, within the recreational vehicle, or inside the boat. Lifting conventional dollies into any of these transportation locations with their designed in weight and awkward shapes would present the average person with a significant challenge. Trailer dollies with the battery included also increase the risk of battery acid leakage should the battery be stored in a non-upright position. AC electrically powered trailer dollies require that an appropriate power outlet is available at all locations at which the trailer dolly is to be used and care must be taken to avoid the presence of water in and around the area of usage. By design, trailers are frequently near water in the form of rain, puddles, landscaping, etc. Simplified maneuvering must include forward and reverse modes. Finally, a method of gradually increasing power to slowly accelerate the dolly is critical for the control and simplified operation.

### SUMMARY OF THE INVENTION

In accordance with the present invention, a trailer dolly includes an internal combustion engine, a transmission providing both forward and reverse drives, and a centralized lifting handle. The internal combustion engine provides much better power and much less weight than electric counterparts. As other lightweight alternatives to electric motors become available, such alternatives can be used in place of the internal combustion engine. The forward/reverse transmission overcomes the disadvantages of conventional trailer dollies powered by internal combustion engines, namely, awkward control and maneuvering. The transmission constructed in accordance with the present invention is simple and lightweight—and therefore particularly well-suited for use in trailer dollies. Due to the exceptionally light weight achieved with the internal combustion engine and the lightweight and simple transmission, the lifting handle mounted generally at the center of gravity makes single-handed lifting and carrying of the trailer dolly quite easy.

Further in accordance with the present invention, the trailer dolly can be mounted on an adapted trailer dolly mount on the trailer itself. Thus, the trailer dolly can be easily transported with the trailer. The trailer mount includes generally a post that the trailer dolly can be set upon. A locking pin holds the trailer dolly on the mount securely during transportation.

Thus, the trailer dolly according to this invention surpasses any currently available product. This trailer dolly is light in weight, hand carried, easily maneuverable, overall simple in design, and stores on the trailer. The trailer dolly is small yet more powerful than competing designs.

### BRIEF DESCRIPTION OF THE DRAWINGS

FIG. 1 is a side view of a trailer dolly in accordance with the present invention.

FIG. 2 is a perspective view of a transmission of the trailer dolly of FIG. 1 in greater detail.

FIG. 3 is a perspective view of a connection accessory for adapting a trailer for use with the trailer dolly of FIG. 1.

FIG. 4 is a perspective view of a trailer which is adapted for use with the trailer dolly of FIG. 1 and which includes a mounting posted onto which the trailer dolly of FIG. 1 can be mounted for transportation.

FIG. 5 is a perspective view of an alternative trailer dolly according to the present invention and which includes two wheels.

FIG. 6 is a perspective view of a trailer which includes a storage case which is adapted to store the trailer dolly of FIG. 1.

FIGS. 7-8 are each a cross-section view of a centrifugal clutch of the trailer dolly of FIG. 1 with the clutch cylinder in a different respective position.

FIG. 9 is a plan view of an alternative transmission for use with the trailer dolly of FIG. 1.

FIG. 10 is a side view of sprockets and a chain which form part of a forward drive of the transmission of FIG. 9.

FIG. 11 is a side view of sprockets and a chain which form part of a reverse drive of the transmission of FIG. 9.

### DETAILED DESCRIPTION

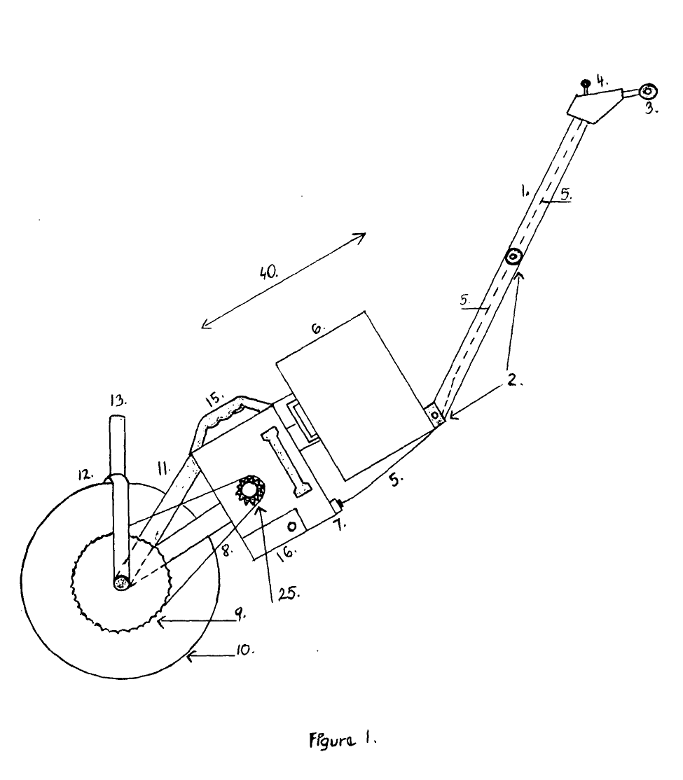

In accordance with the present invention, a trailer dolly 40 as shown in FIG. 1 includes an internal combustion engine 6, a transmission 7, and a wheel 10 which are coupled to one another in a linear arrangement and liftable by a handle 15 near the center of gravity of engine 6, transmission 7, and wheel 10. Transmission 7 is designed to be simple and light while providing both forward and reverse drive, thereby greatly simplifying maneuvering of trailer dolly 40, and therefore any trailer attached thereto, while still achieving the power and weight advantages of an internal combustion engine.

Engine 6, transmission 7, and wheel 10 are positioned close to one another to concentrate mass in a relatively small package. Thus, arms and moments relative to handle 15 are minimized to thereby minimize angular and linear momentum relative to handle 15. Accordingly, single-handed carrying of of trailer dolly 40 by handle 15 is quite easy.

A number of advantages are realized by trailer dolly 40 of FIG. 1. Use of an internal combustion engine, e.g., engine 6, allows for minimal weight for the requisite power and the freedom of working around water, which is a problem for electrically powered trailer dollies. In addition, transmission 7 has both a forward and a reverse gear (as described more completely below) and therefore avoids elaborate mechanisms to enable awkward orientations of the trailer dolly relative to a towed trailer. Use of a centrifugal clutch greatly simplifies construction and operation of trailer dolly 40. In particular, an operator need only close the throttle of engine 6 to both stop driving trailer dolly and release transmission 7 for shifting between forward and reverse gears.

Fork 12 supports a trailer at a fork opening 13 over a single wheel 10 in a substantially vertical position. Fork opening 13 is a hollow cylinder which forms a trailer coupler which couples with a maneuvered trailer in a manner described below. Since fork opening 13 is substantially directly above wheel 10, an operator of trailer dolly 40 can rotate trailer dolly 40, and therefore wheel 10, about a fork opening 13 at the top of fork 12 by simply pushing handle grips 3 left or right to thereby steer trailer dolly 40. During such rotation, wheel 10 simply pivots under fork opening 13. Transmission 7 and engine 6 are fixed to fork 12 at an acute angle, e.g., an acute angle such as 20-25 degrees, such that ground clearance below transmission 7 and engine 6 is increased, stress at the joint between fork 12 and a transmission bracket 11 is reduced, and a handle 1 can be shortened while still being comfortably reachable by a typical human operator. Handle 1 is collapsible for storage and locks into position with pins 2 when in use. Handle grips 3 include controls 4 to provide the operator with throttle, brake, and transmission shifting control. The controls are linked by cables 5 to engine 6 and transmission 7.

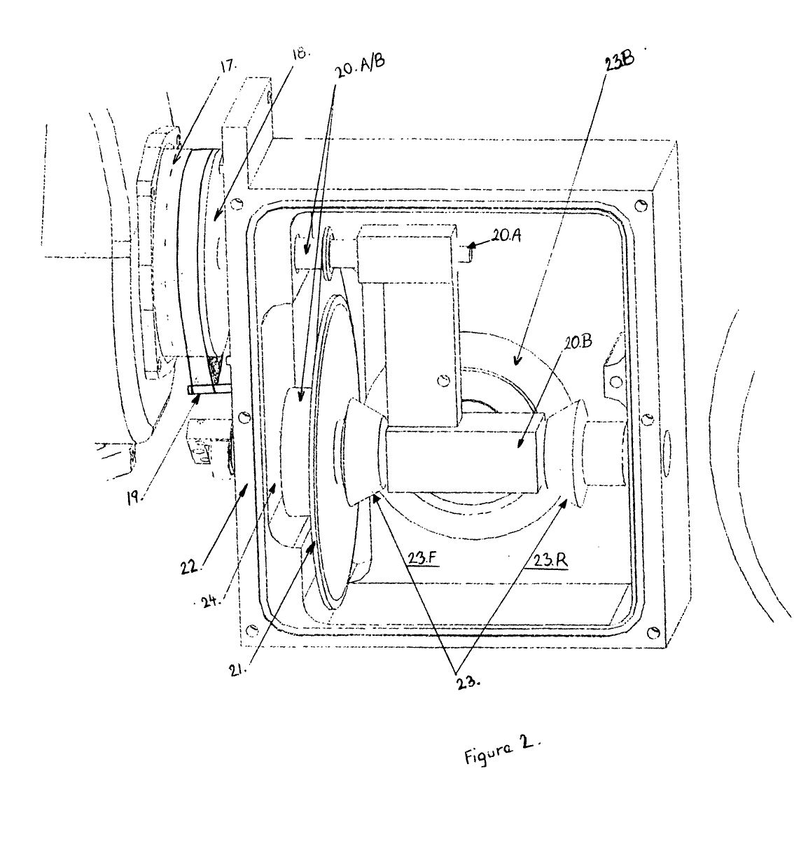

In this illustrative embodiment, engine 6 produces approximately 1.5 horsepower and is a four-stroke design for improved starting, cleanliness, and reduced noise. Transmission 7 houses forward and reverse gears selectable by the cable and control linkage on the handle. In this illustrative embodiment, engine 6 typically runs at about 6,000-7,000 revolutions per minute and transmission 7 provides a collective reduction of about 130 to 1 such that trailer dolly 40 typically travels at about 2 miles per hour during operation. Transmission 7 is shown in greater detail in FIG. 2 and is described briefly here and in greater detail below. Transmission 7 includes a reduction 21, a band brake 19, and a centrifugal clutch 17. Transmission 7 drives a sprocket 25 (FIG. 1) which in turn drives a chain 8 connected to a sprocket 9 directly attached to wheel 10. When in operation, wheel 10 provides the support for the trailer and also turns—powered by engine 6 through transmission 7—providing the forward and reverse motion of trailer dolly 40. Wheel 10 and transmission 7 are connected to one another by transmission bracket 11. Transmission bracket 11 has adjustment capability to insure proper chain tension over time. Specifically, the axle of wheel 10 is bolted to slots in transmission bracket 11 much like a rear wheel of a bicycle, thereby allowing the tension on chain 8 to be adjusted in an analogous manner.

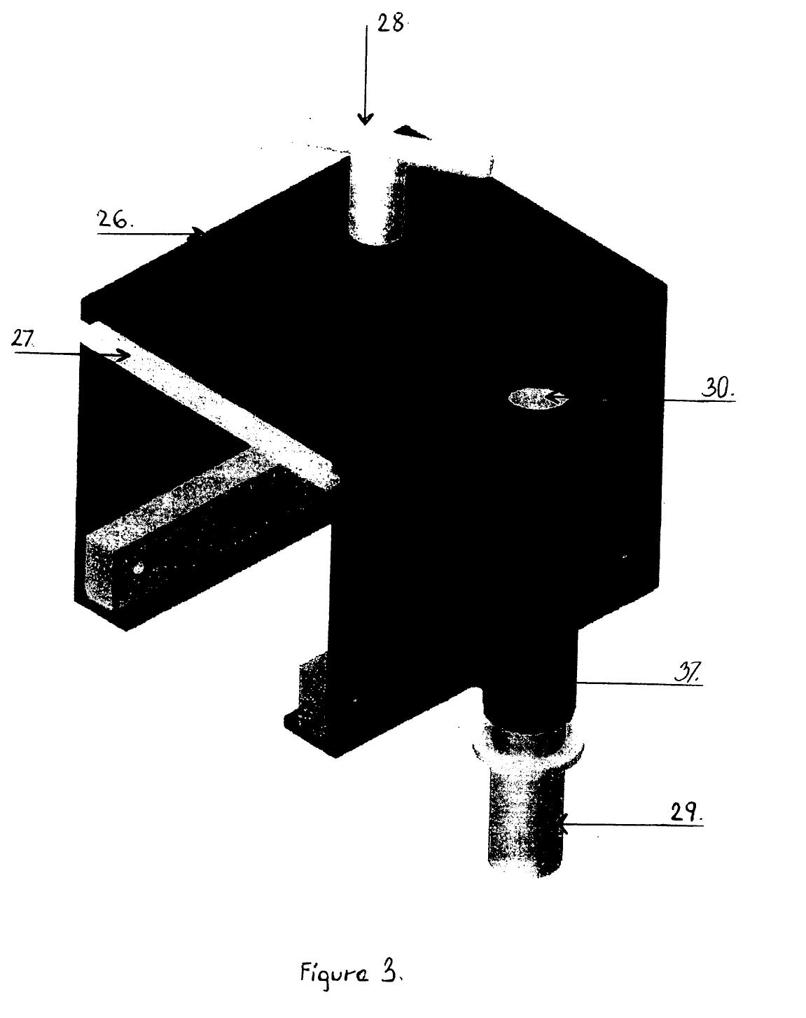

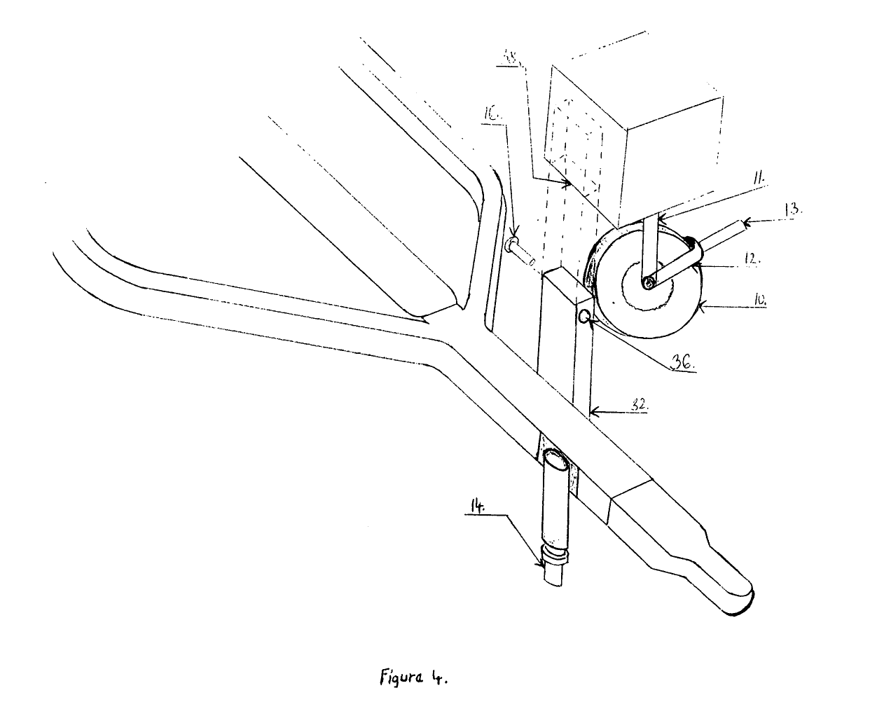

The upper part of the transmission bracket 11 includes fork 12. Fork 12 includes a top opening 13, which is a hollow cylindrical tailer coupler as described above, into which a sturdy pin 14 (FIG. 4) can slide or be lowered. Within fork opening 13, a bushing reduces friction during rotation about sturdy pin 14 as the trailer dolly is steered. Sturdy pin 14 can be included as an integral part of the trailer as shown in FIG. 4 or can be attached by an accessory device shown in FIG. 3 (and described more completely below).

A trailer receiver post 32 (FIG. 4) is attached to a trailer for mounting trailer dolly 40 for transporting trailer dolly 40 along with the towed trailer. In this illustrative embodiment, trailer receiver post 32 is welded to the trailer. In an alternative embodiment, trailer receiver post 32 is bolted to the trailer in such a manner that trailer receiver post 32 can be removed without damage to the trailer. Trailer receiver post 32 includes an opening 36 through which a lockable pin 16 of trailer dolly 40 can be inserted and into which lockable pin 16 can be locked (e.g., using a carter pin). Trailer receiver post 32 thus receives, supports, and holds trailer dolly 40. A lifting handle 15 (FIG. 1) is located near the center of gravity of trailer dolly 40 and is used for lifting the device to the trailer storage position, i.e., with lockable pin 16 inserted through opening 36 (FIG. 4), or to the maneuvering position, e.g., with sturdy pin 14 inside fork opening 13 (FIG. 1), for use moving the trailer. Using a simple waterproof cover with sealed zipper, the trailer dolly can stored on the trailer during non-operation in a manner in which the trailer dolly is protected from the elements.

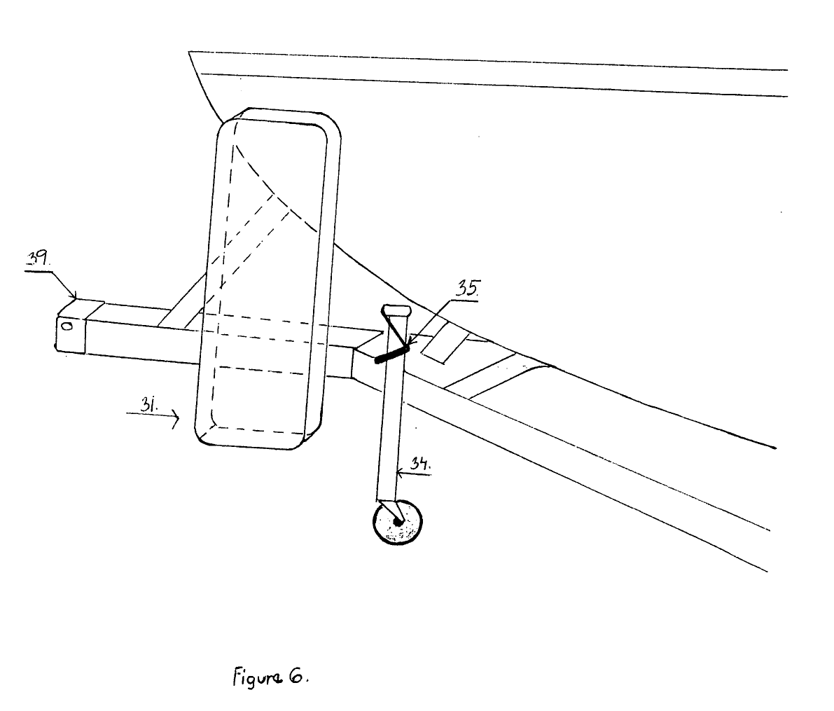

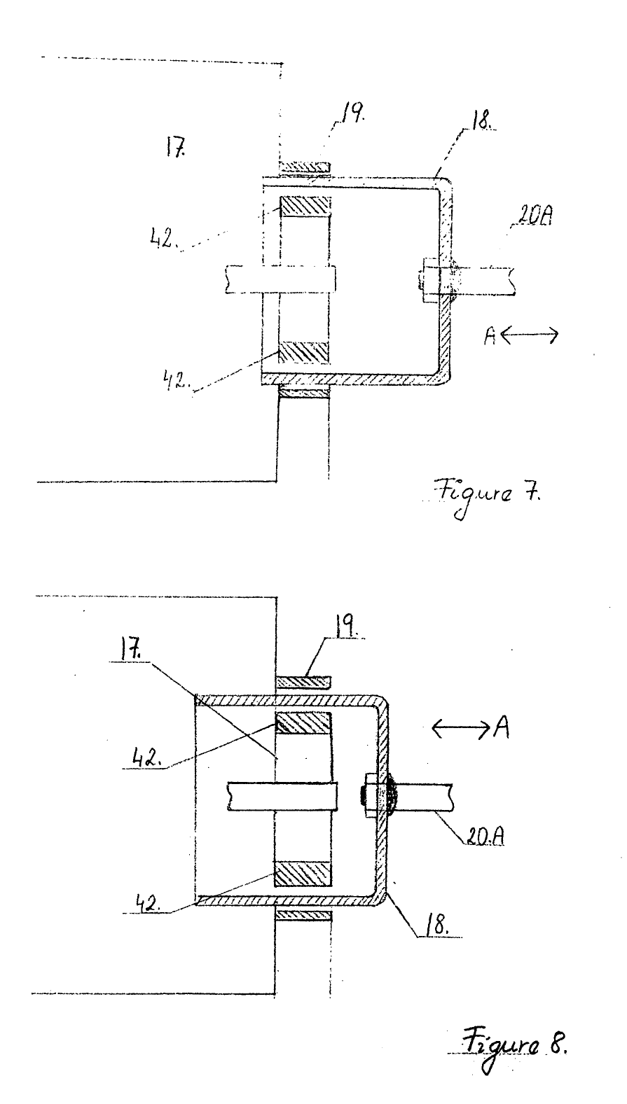

As described briefly above, transmission 7 (FIG. 2) includes forward and reverse gears and uses a centrifugal clutch. Centrifugal clutch 17 engages the inside of a clutch cylinder 18. On the outside of the clutch cylinder, a band brake 19 includes controls that enable use of band brake 19 when the throttle is not engaged. It should be noted that clutch cylinder 18 is mounted to a sliding shaft 20 which allows the centrifugal clutch 17 to engage the clutch cylinder 18 in multiple positions. Specifically, clutch cylinder 18 is slideable as shown in greater detail in FIGS. 7-8 in the direction of arrow A. Centrifugal clutch pads 42 and band brake 19 remain in fixed locations relative to engine 6 and transmission 7 while clutch cylinder 18 moves with upper shaft 20A of sliding shaft 20.

One or more reductions 21 are included on the opposite side of a sealed oil partition 22. Reduction 21 is a chain and sprocket reduction in the illustrative embodiment. Reduction 21 connects to the forward and reverse gears 23F and 23R, respectively, located at the opposite end of lower shaft 20B of sliding shaft 20. Gears 23F and 23R are bevel gears and engageable with a bevel gear 23B. When sliding shaft 20 slides, reduction 21, forward gear 23F, and reverse gear 23R slide with it. Sliding of gears 23F and 23R alternatively engages forward gear 23F or reverse gear 23R with bevel gear 23B. A spring 24 provides tension on the shifter control cable of cables 5 (FIG. 1) which controls sliding of sliding shaft 20 (FIG. 2) and therefore selected engagement of forward gear 23F or reverse gear 23R with bevel gear 23B. A sprocket 25 (FIG. 1) is driven by bevel gear 23B (FIG. 2) to thereby drive chain 8 (FIG. 1) connected to wheel 10 and thus power movement and trailer dolly 40 and any trailer attached thereto.

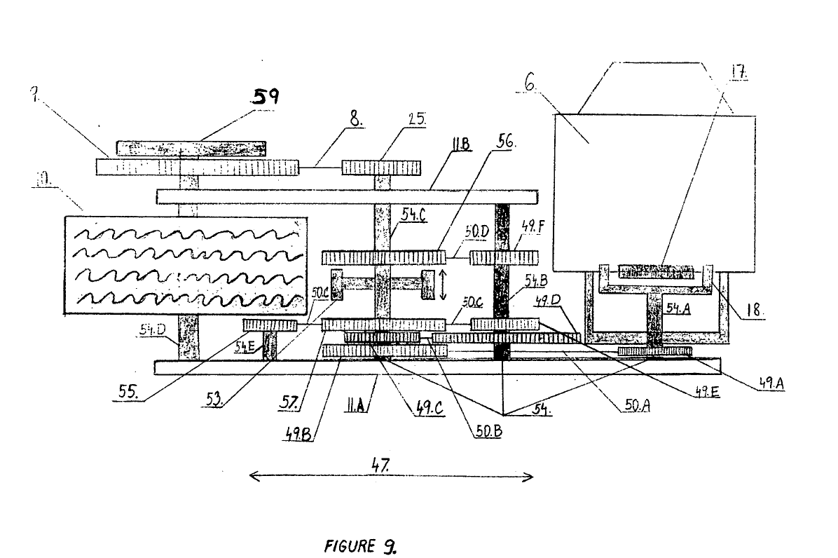

The primary advantages of transmission 7 is that transmission 7 is very simply and light-weight while still providing both forward and reverse gears for easily maneuvering of trailer dolly 40 and an attached trailer. In addition, transmission 7 is quite compact and helps keep the mass of trailer dolly 40 concentrated in a relatively small package further facilitating easy handling of trailer dolly 40. An alternative to transmission 7 is described below in conjunction with FIG. 9.

FIG. 3 shows a connection accessory (sometimes referred to as trailer connector 26) by which the trailer dolly of FIG. 1 can be used to move a trailer without a permanent sturdy pin (FIG. 4) installed. Trailer connector 26 includes a semi-closed, inverted “U” shape. Within the “U” is a clamp plate 27 and a clamp handle 28 which can be turned to tighten trailer connector 26 to a trailer frame. To the side of the “U”, a connector pin 29 screws into a sleeve 37 which is welded in place. Connector pin 29 and sleeve 37 have mating adjustment threads 30 that enable the raising or lowering of connector pin 29 to adjust the amount of tongue weight the trailer applies to the trailer dolly. Accessory connector pin 29 is lowered into fork opening 13 (FIG. 1) by lowering the trailer itself using a conventional trailer jack in much the same way the trailer would be lowered onto a vehicle's trailer ball.

FIG. 4 shows a simple post 32 that is a weldment to the trailer frame in this illustrative embodiment. The trailer dolly includes a receiver style opening 38 which slides over post 32 and lockable pin 16 is inserted through the trailer dolly and through opening 36 of post 32. Lockable pin 16 provides a secure position for the trailer dolly while the trailer is being pulled by a tow vehicle and for secure storage.

Alternate embodiments of trailer dolly 40 (FIG. 1) can use different motors and transmissions. While engine 6 is described herein to be an internal combustion engine, alternative engine technologies can be employed as power to weight ratios for such alternative technologies improve. Possible motors and power supplies include, but are not limited to, battery cell, fuel cell, lithium ion battery packs, etc. Current two-stroke high output motors can also be coupled to transmissions to provide the power train functionality. The centrifugal clutch can be replaced with a traditional clutch design or the transmission can be altered to just provide a reduction if a more efficient electrical powered method is introduced.

FIG. 9 shows transmission 47, which is an alternative to transmission 7 described above with respect to FIG. 2. Like transmission 7, transmission 47 (FIG. 9) is light, compact, inexpensive, and provides forward and reverse drive.

In this illustrative embodiment, transmission 47 uses chains and sprockets rather than interlocking gears as do most transmissions. In other embodiments, other types of drive bands are used such as V-belt, cog belts, and flat belts, for example. The result is —that no enclosing case is needed for lubrication. Instead, ordinary chain lubrication is all that is needed or no lubrication at all for belt-type drive bands. By omitting a case to enclose the transmission, transmission 47 is made particularly light. In addition, sprockets and chains—as well as pulleys and belts—are generally less expensive to manufacture as cheaper materials can be used and greater tolerances are allowed.

Transmission 47 uses a dog-tooth disc 53 like a traditional manual automobile transmission. However, dog-tooth disc 53 slides along shaft 54C to mate with holes in sprockets rather than gears, namely, either forward drive sprocket 56 or reverse drive sprocket 57. An operator uses controls 4 to move one of cables 5 to cause dog-tooth disc 53 to slide along shaft 54C to thereby shift between forward, reverse, and neutral drives. The overall operation of transmission 47 is as follows.

Engine 6 output is mounted at a 90-degree angle to the drive wheel when viewed from above as shown in FIG. 9. It should be noted however, that engine 6 is still elevated at an acute angle with respect to the horizontal plane as shown in FIG. 1. Centrifugal clutch 17 engages the inside of clutch cylinder 18 to transmit the torque of engine 6 through transmission 47 to wheel 10. Transmission 47 uses four sets of reductions to reduce the high RPMs (revolutions per minute) of engine 6 to a slower wheel RPM while multiplying the torque at wheel 10. The four reductions include (i) the reduction of sprockets 49A-B and chain 50A, (ii) the reduction of sprockets 49C-D and chain 50B, (iii) the alternative forward-drive and reverse-drive reductions, and (iv) the reduction of sprockets 25 and 19 and chain 8.

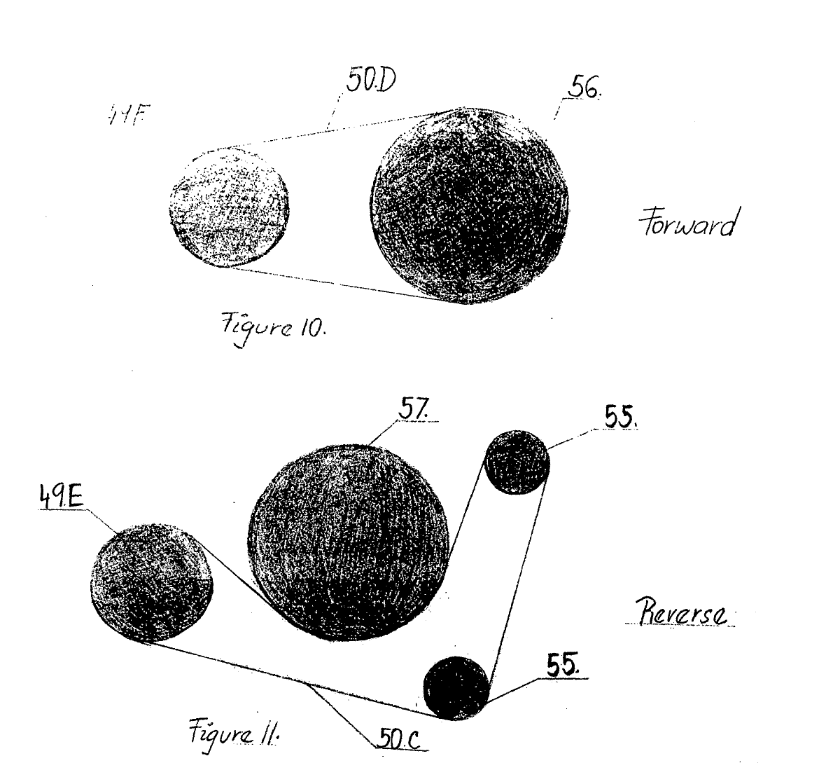

The reduction of the alternative forward and reverse drives are shown in FIGS. 10 and 11, respectively. In FIG. 10, sprocket 49F drives forward sprocket 56 with chain 50D. In FIG. 11, sprocket 49E drives idler sprockets 55 in the forward direction and reverse sprocket 57 in the reverse direction. While two idler sprockets 55 are shown, it should be appreciated that other numbers of idler sprockets 55 can be used.

Engine 6, through centrifugal clutch 17 and clutch cylinder 18, drives shaft 54A which is fixed to sprocket 49A. Sprocket 49A drives chain 50A which in turn drives sprocket 49B. Sprockets 49B-C are fixed to one another and turn independently of the remainder of shaft 54C. Thus, sprocket 49B drives sprocket 49C which in turn drives sprocket 49D. Sprocket 49 turns shaft 54B which in turn drives sprockets 49E-F.

To provide selectable forward and reverse drives, dog-tooth disc 53 is mounted on shaft 54C with the ability to mechanically slide from side to side. Dog-tooth disc 53 is rotationally fixed to shaft 54C so that turning of dog-tooth disc 53 drives shaft 54C and sprocket 25. Forward sprocket 56 and reverse sprocket 57 turn independently of shaft 54C on respective sets of bearings. Dog-tooth disc 53 can engage either forward sprocket 56 or reverse sprocket 57, thereby locking shaft 54C to either forward sprocket 56 or reverse sprocket 57.

The tooth shape on the outside edges of dog-tooth disc 53 is designed to fit into holes cut into sprockets 56-57. Through this ability to slide dog-tooth disc 53 to engage either the of the counter-rotating sprockets, torque can be applied in either direction to shaft 54C, which in turn drives sprocket 25, chain 8, sprocket 9, and wheel 10. If dog-tooth disc 53 is positioned between sprockets 56-57, i.e., engaged with neither, a neutral drive setting is accomplished for rolling the dolly on the ground.

To facilitate adjustment of tensions in chains 50A-D and 8, shafts 54A-E are mounted between transmission brackets 11A-B in slots such that relative positions of shafts 54A-E can be adjusted. In addition, symmetry in sprocket sizes enables adjustment of multiple chains by movement of a single shaft. In particular, in this illustrative embodiment, sprockets 49C, 49E, and 49F are equal in size, and sprockets 49D, 56, and 57 are equal in size. In addition, chains 50B and 50D are the same length. Thus, the amounts by which tensions of multiple chains are adjusted by movement of shaft 54B alone are the same, and by moving shaft 54B relative to shaft 54C, tensions of chains 50B-D can be adjusted at once. Chain 50C can be adjusted independently by moving shaft 54E.

A brake assembly 59 is attached to shaft 54D and is controlled by controls 4 and cables 5. Various types of brakes can be used, including band brakes, drum brakes, and disc brakes for example. Brakes commonly used on go carts generally provide sufficient stopping force and are small and relatively inexpensive. A brake may be unnecessary as weight of a trailer applied to wheel 10, whose tire is inflated to 10-15 lbs. per square inch for example, can generate enough rolling resistance in addition to the rolling resistance already provided by the tires of the trailer itself to avoid unintended rolling of the trailer. However, inclusion of a brake is preferred to an added margin of safety and controllability.

As with transmission 7 (FIG. 2), transmission 47 (FIG. 9) is simple, light, and easy to control. The operator starts engine 6 (e.g., using a pull-start cord which is conventional and not described herein). At idle, centrifugal clutch 17/18 is not engaged. The operator selects a gear by moving control 4 and locking the control in a forward or reverse position. The controls are lockable in a conventional manner used on many lawnmowers—the control lever is moved in one direction to select a drive mode and then is moved in a perpendicular direction to lock the control in place. By locking the transmission control of controls 4 into place, dog-tooth disc 53 is locked in an engaged position with either forward sprocket 57 or reverse sprocket 56.

By gradually opening the throttle of engine 6 (e.g., by moving a throttle lever of controls 4 or by using a twist-grip throttle control—either of which moves a throttle cable of cables 5), the operator causes centrifugal clutch 17/18 to gradually engage and apply force through transmission 47 to wheel 10. Closing the throttle disengages centrifugal clutch 17/18 and allows the operator to select the other drive by repeating the simple process described above.

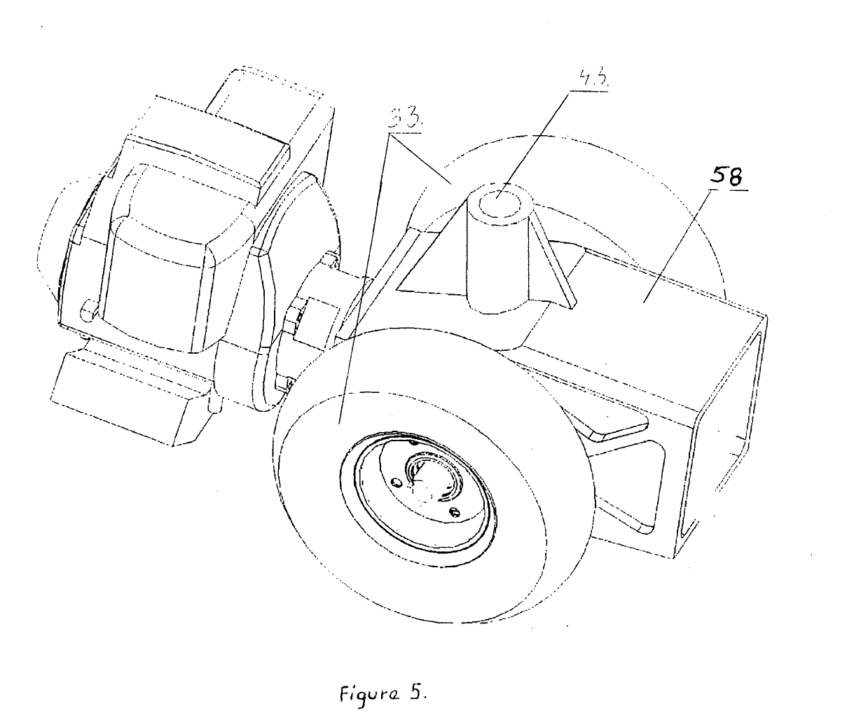

FIG. 5 shows an alternative embodiment leveraging the innovations described above with respect to FIGS. 1-4 with the exception of having two wheels 33. In addition, a socket 43 is positioned between, and over the centers of, wheels 33 to receive sturdy pin 14 (FIG. 4). As described above with respect to fork opening 13 (FIG. 1), socket 43 (FIG. 5) is a hollow cylinder which forms a trailer coupler. A transmission 58 (FIG. 5) includes a geared drive reduction which would have otherwise been provided by the gearing of chain 8 (FIG. 1) in addition to forward and reverse drives as described above with respect to FIGS. 2 and 9.

In FIG. 6, the trailer dolly does not use the receiver coupling with locking pin 16 and receiver style opening 38 as previously mentioned. Instead, the trailer dolly is carried in a lockable hard shell storage case 31 mounted to the trailer. In this embodiment, storage case 31 receives, supports, and holds the trailer dolly—both for storage and during transportation. It is preferred that storage case prevents movement of the trailer dolly within storage case 31 during towing of the trailer.

To facilitate understanding of the usage of the trailer dolly of FIG. 1, such usage is described herein in the form of a chronology. Initially, the trailer has been disconnected from the tow vehicle, e.g., either a car or truck, and trailer dolly 40 is mounted on trailer receiver post 32 as described above with respect to FIG. 4. The first step is to remove trailer dolly 40 from the storage position on the trailer. In this illustrative embodiment, an operator of trailer dolly 40 removes lockable pin 16 and lifts trailer dolly 40 off trailer receiver post 32 by using lifting handle 15. This motion releases trailer dolly 40 from its storage position on the trailer.

The trailer is in a position supported by the trailer jack, e.g., trailer jack 34 (FIG. 6). Generally, most trailers in use today include a trailer jack such as trailer jack 34. In a conventional manner, trailer jack 34 allows the human operator to lift and lower the trailer coupling 39 by the trailer jack crank handle 35. In the embodiment described above with respect to FIGS. 1-4, trailer dolly 40—now removed from trailer receiver post 32—is positioned under connector pin 29 (FIG. 3) or sturdy pin 14 (FIG. 4). The trailer should be raised (using trailer jack 34) to a height at which fork opening 13 (FIG. 1) can be moved under sturdy pin 14 (FIG. 4) with a bit of extra clearance. The operator uses trailer jack 34 to lower the trailer such that sturdy pin 14 moves into fork opening 13 of fork 12 until the weight of the trailer is transferred to trailer dolly 40 from the trailer jack. During the lowering of sturdy pin 14 into fork opening 13, it may be necessary for the operator to jockey trailer dolly 40 until sturdy pin 14 is fully seated within fork opening 13.

With sturdy pin 14 fully seated within fork opening 13, the operator starts engine 6. In this illustrative embodiment, engine 6 is started by a pull-cord much like a typical lawn mower. It does not matter whether forward or reverse gear is selected at engine start since the centrifugal clutch 17 does not engage during the staring process or during idling of engine 6. The operator selects the appropriate gear using control 4, either forward or reverse, and holds handle grips 3. As the operator increases the throttle (which can be either a twisting grip or a lever near handle grips 3), centrifugal clutch 17 engages, thus transferring drive power through transmission 7 (or alternatively transmission 47) to wheel 10. As wheel 10 is driven, the trailer begins to move in the intended forward or reverse direction. To stop the motion, the throttle is released (thus lowering RPM and consequently disengaging centrifugal clutch 17) and the operator applies pressure on a brake lever of controls 4 on handle grips 3 to provide additional stopping power through band brake 19 (FIG. 2). Since centrifugal clutch 17 is disengaged, the operator is free to switch between forward and reverse drives at this point. This process can be repeated by the operator as necessary to move the trailer in forward and reverse directions. The trailer dolly, and thus the trailer itself, is steered by the operator moving handle grips 3 left or right to thereby rotate wheel 10 and fork 12 about sturdy pin 14. The process of maneuvering the trailer is complete when the trailer is either positioned in the desired parking position or is positioned close to the tow vehicle, either a car or truck.

Once the trailer is in the desired position, the operator shuts down engine 6. The operator extends trailer jack 34 to lift the trailer off trailer dolly 40, providing a bit of vertical clearance between fork opening 13 and sturdy pin 14. The operator rolls trailer dolly 40 clear of sturdy pin 14 and lifts the trailer dolly by lifting handle 15. The operator places receiver style opening 38 of trailer dolly 40 back on trailer receiver post 32. The locking pin 16 is replaced and trailer dolly 40 is in storage until the next required maneuvering operation. A secure cover can be placed over the trailer dolly for protection against the elements.

Although the description above contains much specificity, this description should not be construed as limiting the scope of the invention but as merely providing illustrations of some of the presently preferred embodiments of this invention. For example, the trailer dolly can have other shapes, more wheels, a different mechanism for mounting on the trailer, different connections to the trailer, different motor and power options, etc. A locking coupling to the trailer could be provided that covers the ball coupling and serves as a lock and connection to the dolly. The dolly could be placed in a carrier instead of placed on a post and receiver combination. In fact, the dolly could be stored in a place other than the trailer if the operator has different requirements.

Thus, the scope of the invention should be determined by the claims and their legal equivalents rather than by the examples given.

1. A trailer dolly comprising:
a motor;
at least one wheel;
a transmission coupled between the motor and the wheel and which includes both a forward drive and a reverse drive and which can transmit a rotational force through either the forward drive or the reverse drive from the motor to the wheel; and
a trailer coupler coupled to the wheel in a position at which the wheel can support a weight of a trailer coupled at the trailer coupler.

2. The trailer dolly of claim 1 further comprising:
a clutch which enables selective engagement and disengagement of the transmission to the motor.

3. The trailer dolly of claim 2 wherein the clutch is a centrifugal clutch.

4. The trailer dolly of claim 3 wherein the transmission comprises:
a sliding member which can engage either the forward drive or the reverse drive.

5. The trailer dolly of claim 4 wherein the centrifugal clutch comprises a clutch cylinder and further wherein the clutch cylinder slides with the sliding member and is engageable whether the sliding member is engaging the forward drive or the reverse drive.

6. The trailer dolly of claim 1 wherein the motor is an internal combustion engine.

7. The trailer dolly of claim 1 wherein the transmission comprises:
a sliding member which engages the forward drive when the sliding member is in a forward drive position and engages the reverse drive when the sliding member is in a reverse drive position.

8. The trailer dolly of claim 7 wherein the sliding member includes forward and reverse gears which rotate together;
further wherein the transmission further comprises a driven gear;
further wherein engagement of the forward drive comprises engagement of the forward gear with the driven gear to drive the driven gear in a first direction; and
further wherein engagement of the reverse drive comprises engagement of the reverse gear with the driven gear to drive the driven gear in a second direction which is opposite to the first direction.

9. The trailer dolly of claim 8 wherein the forward, reverse, and driven gears are bevel gears.

10. The trailer dolly of claim 7 wherein the forward drive includes a forward rotating member which rotates in a first direction to drive a forward band when driven by the motor;
further wherein the reverse drive includes a reverse rotating member which rotates in a second direction, which is different than the first direction, to drive a reverse band when driven by the motor; and
further wherein the sliding member engages the forward rotating member when in the forward drive position and engages the reverse rotating member when in the reverse drive position.

11. The trailer dolly of claim 10 wherein the forward and reverse rotating members are forward and reverse sprockets, respectively; and
further wherein the forward and reverse bands are forward and reverse chains, respectively.

12. The trailer dolly of claim 10 wherein the forward and reverse rotating members are forward and reverse pulleys, respectively; and
further wherein the forward and reverse bands are forward and reverse belts, respectively.

13. The trailer dolly of claim 12 wherein the forward and reverse belts are forward and reverse V-belts, respectively.

14. The trailer dolly of claim 12 wherein the forward and reverse belts are forward and reverse notched belts, respectively.

15. The trailer dolly of claim 10 wherein the sliding member comprises a dog-tooth gear which is capable of engaging matching holes with the forward and reverse rotating members.

16. The trailer dolly of claim 10 wherein the transmission includes at least one drive reduction which in turn includes at least two reduction rotating members and a reduction band operatively coupled to the reduction rotating members.

17. A trailer dolly comprising:
a motor;
at least one wheel operatively coupled to the motor;
a trailer coupler coupled to the wheel in a position at which the wheel can support a weight of a trailer coupled at the trailer coupler; and
a lifting handle mounted to an assembly which includes the motor and the wheel-substantially at a center of gravity of the assembly when the assembly is in a substantially horizontal orientation.

18. The trailer dolly of claim 17 further comprising:
a transmission which includes a forward drive and a reverse drive operatively coupled between the motor and the wheel to thereby apply a force of the motor to the wheel through a selected one of the forward and reverse drives.

19. The trailer dolly of claim 17 wherein the motor is an internal combustion engine.

20. A mounting system attachable to a trailer capable of being maneuvered by a trailer dolly, the mounting system comprising:
a mounting member which is adapted to receive, support, and hold the trailer dolly.

21. A method for transporting a trailer dolly with a trailer which is maneuverable by use of the trailer dolly, the method comprising:
lifting the trailer dolly by a handle of the trailer dolly;
placing the trailer dolly in a mounted position wherein a trailer dolly mount of the trailer supports the trailer dolly.

22. The method of claim 21 wherein the trailer dolly mount includes a protrusion which fits into a mount recess of the trailer dolly; and
further wherein the mounted position includes the protrusion positioned within the mount recess.

23. The method of claim 21 wherein the trailer dolly mount include a case which is designed to support and enclose the trailer dolly; and
further wherein the mounted position includes the trailer dolly positioned and enclosed within the case.

24. The method of claim 21 wherein the mounted position is such that the trailer dolly mount holds the trailer dolly substantially immobilized for secure transportation of the trailer dolly in the mounted position by towing of the trailer.
